(19) United States
(12) Patent Application Publication
(10) Pub. No.: US 2025/0341242 A1
(43) Pub. Date: Nov. 6, 2025

(54) TORSION SPRING MECHANISM WITH AN OVAL PILOT

(71) Applicant: Shantanu Singh, Ghaziabad (IN)

(72) Inventor: Shantanu Singh, Ghaziabad (IN)

(21) Appl. No.: 19/087,476

(22) Filed: Mar. 22, 2025

(30) Foreign Application Priority Data
Feb. 27, 2025 (IN) 202511017109

(51) Int. Cl. F16F 1/16

(52) U.S. Cl. CPC F16F 1/16; B60G 7/001; F16F 2238/024

(57) ABSTRACT

Conventional torsion-springs store and release rotational-energy to apply torque for restoring components to a stable-equilibrium orientation but are often intricate to manufacture, fatigue-prone, bulky and unsuitable for complex torque-profiles. The present invention discloses a torsion-spring assembly comprising a pivot with an oval cross-section rigidly attached to a platform (1) and a lever-arm (6) with an integrated knuckle-eye (4,5). The pivot consists of circular and continuous non-circular semi-cylindrical sections (2) and (3), seamlessly joined along identical surfaces formed by splitting along respective diametral-planes, ensuring structural continuity. The knuckle-eye, featuring a complementary oval-hole, is mounted onto the pivot, enabling controlled rotation. The geometric-mismatch induces elastic-deformation in the knuckle-eye upon rotation (B), generating shear strain and stress, which produce a restoring-torque (T) opposing the rotation. This design enables compactness, precise torque control, reduced fatigue, simplified manufacturing, and adaptability for complex torque responses or multiple stable-equilibrium orientations.

### CROSS-REFERENCE TO RELATED APPLICATIONS

The present application claims the benefit of foreign priority to copending Indian Non-provisional Patent-application Ser. no. 202511017109, filed on Feb. 27, 2025 and entitled “TORSION SPRING MECHANISM WITH AN OVAL PIVOT”, the entire contents of which are incorporated herein by reference in their entirety for all purposes.

### BACKGROUND OF THE INVENTION

### Field of the Invention

The present invention relates to mechanical-springs, specifically to a torsion-spring assembly utilizing an oval-pivot configuration for generating a restoring-torque through elastic-deformation of a knuckle-eye component.

### Description of the Related Art including information disclosed under 37 CFR 1.97 and 37 CFR 1.98

Torsion-springs are widely used in mechanical-systems to store and release rotational-energy or to exert a torque to return components to an equilibrium-orientation. Conventional torsion-springs typically consist of coiled-wires or helical-structures that resist rotation, as exemplified in the U.S. Pat. No. 5,464,197A, titled “Torsion-spring Having an Adjustable Spring Rate”. This patent describes a helical torsion-spring with an adjustable spring-rate, featuring a main-spring formed from a coil of wire with first and second arms, torsionally loaded by angular-displacement and an adjustment spring within the coil's core to threadably modify the spring-rate. However, such designs are complex to manufacture and assemble, prone to fatigue over repeated cycles and limited in applications requiring compact assemblies and specialized torque profiles. So, there exists a need for a simplified torsion-spring design that leverages geometric-distortion for torque generation, offering durability, ease of manufacture and adaptability to various mechanical-systems.

### SUMMARY OF THE INVENTION

The present invention provides a torsion-spring assembly comprising an oval-pivot and a lever with a knuckle-eye. The pivot features a unique oval cross-section perpendicular to its rotational-axis, with one half being a circular semi-cylinder and another a continuous non-circular semi-cylinder. The knuckle-eye of the lever includes a complementary hole that fits over the pivot. The lever-arm extends from the circular semi-cylindrical section of the knuckle-eye. When the lever is rotated relative to the pivot, the geometric-mismatch between the knuckle-eye's hole and the pivot induces elastic shear-strain in the knuckle-eye. This shear-strain induces a shear-stress, which in turn generates a restoring-torque that drives the lever back toward its natural stable-equilibrium orientation relative to the pivot.

This design eliminates the need for coiled-elements, reduces manufacturing-complexity and allows for customizable torque-characteristics by varying the pivot's geometry or the knuckle-eye's material-properties.

### BRIEF DESCRIPTION OF THE DRAWINGS

The invention is described with reference to the accompanying drawings, wherein:

FIGS. 1A and 1B respectively illustrate perspective-views of a circular cylinder (C) and an elliptical cylinder (E), both having identical dimensions, namely equal heights and widths, with the widths corresponding to the diameter of (C) and the minor-axis of (E). Each cylinder is bisected by a flat diametral-plane, forming a circular semi-cylindrical section (2) and an elliptical semi-cylindrical section (3), with the first diametral-plane (P) for section (C) and the second diametral-plane (P′) for section (E). Notably, the plane (P′) passes through the minor-axis (M) of section (3) and is perpendicular to its major-axis (M′).

FIGS. 1C, 1D and 1E respectively illustrate two exploded-views and a perspective-view of the oval-pivot, comprising sections (2) and (3) seamlessly joined together, wherein diameter (D) and height (H) of section (2) are equal to minor-axis (M) and height (H′) of section (3), respectively, ensuring geometric continuity. The sections join along their identical surfaces(S) and (S′), which are formed along the diametral-planes (P) and (P′), thereby creating a continuous oval cross-section (O) perpendicular to the pivot's rotational-axis (R), which is formed when the longitudinal axes (L) and (L′) of both sections coincide. Additionally, (A) denotes the coincident diameter (D) of section (2), the minor-axis (M) of section (3) and a seam where both the sections join, while (B) also represents a seam of these sections.

FIGS. 1F, 1G, 1H and 1I respectively illustrate the top, auxiliary, side orthographic and perspective views of the oval-pivot assembly, comprising a cuboidal platform (1) rigidly joined to the oval-pivot (2,3), ensuring a fixed rotational constraint.

FIGS. 2A, 2B, 2C and 2D respectively illustrate the top, auxiliary, side orthographic and perspective views of a lever with an oval knuckle-eye. The knuckle-eye comprises a circular semi-cylindrical wall (4) and an elliptical semi-cylindrical wall (5) of constant thickness (T), together forming an hole (h) complementary to the oval-pivot. A cuboidal lever-arm (6) of length (L*) extends outward from the wall (4), providing mechanical-leverage. When the lever rotates, the knuckle-eye undergoes controlled elastic-deformation due to the geometric-mismatch between its internal-profile and the pivot, inducing shear-strain in the knuckle-eye and the resultant shear-stress generates a restoring-torque.

FIGS. 3A, 3B, 3C and 3D respectively illustrate the top, auxiliary, side orthographic and perspective views of the knuckle-eye's assembly onto the oval-pivot. These figures depict the mounting process, wherein the knuckle-eye, featuring a hole geometrically complementary to the pivot, is initially positioned and oriented to achieve precise alignment between its hole and the pivot. The knuckle-eye is then progressively slid onto the pivot along the indicated arrows, ensuring accurate geometric engagement prior to final assembly.

FIGS. 4A, 4B, 4C and 4D respectively illustrate the top, auxiliary, side orthographic and perspective views of the torsion-spring mechanism in an unrotated and undistorted state, free from external torques. In this configuration, the knuckle-eye, shown fitted onto the oval-pivot, maintains an undistorted geometric alignment at a stable-equilibrium orientation.

FIGS. 5A, 5B, 5C and 5D respectively illustrate the top, auxiliary, side orthographic and perspective views of the torsion-spring mechanism in a rotated and elastically deformed state, emphasizing its torsional response under load. In this configuration, the lever-arm (6) is displaced by an externally applied anti-clockwise torque, causing an angular-displacement (B) from its stable-equilibrium orientation (indicated by dashed-line). As the knuckle-eye remains mounted onto the oval-pivot, it undergoes elastic-deformation to accommodate the geometric-mismatch between its internal-profile and the pivot. This deformation induces shear-strain, which in turn, generates a corresponding shear-stress, ultimately producing a restoring-torque that counteracts the applied torque and angular-displacement.

FIG. 5E illustrates the knuckle-eye (4,5) in both the unrotated and undistorted state (left-side drawing) and the rotated and elastically deformed state (right-side drawing), demonstrating its elastic response to torsional loading.

FIG. 6 illustrates a top-orthographic view of the torsion-spring mechanism, depicting the interaction between the oval-pivot and the lever's knuckle-eye in a rotated and elastically deformed state. The elastic elliptical-wall (5) of the knuckle-eye deforms upon rotation, conforming to the shape of the rigid elliptical-section (3) of the pivot due to their designed geometric-mismatch. Consequently, the rigid circular-wall (4) of the knuckle-eye applies a net normal-force (left straight-arrow) on the rigid circular-section (2) of the pivot at their effective contact-point, with its line of action (left slanted dashed-line) passing through the pivot's rotational-axis, denoted by (x). Simultaneously, the elastic elliptical-wall (5) applies a net normal-force (right straight-arrow) on the rigid elliptical-section (3) of the pivot at their effective contact-point, but with its line of action (right slanted dashed-line) offset from the pivot's rotational-axis (x) due to their non-circular shapes. The corresponding equal and opposite non-collinear reaction-forces generate a force-couple that induces a restoring-torque (T) on the knuckle-eye, opposing the applied external torque and being proportional to the angular-displacement (B) of the lever-arm (6) from its stable-equilibrium orientation (horizontal dashed-line).

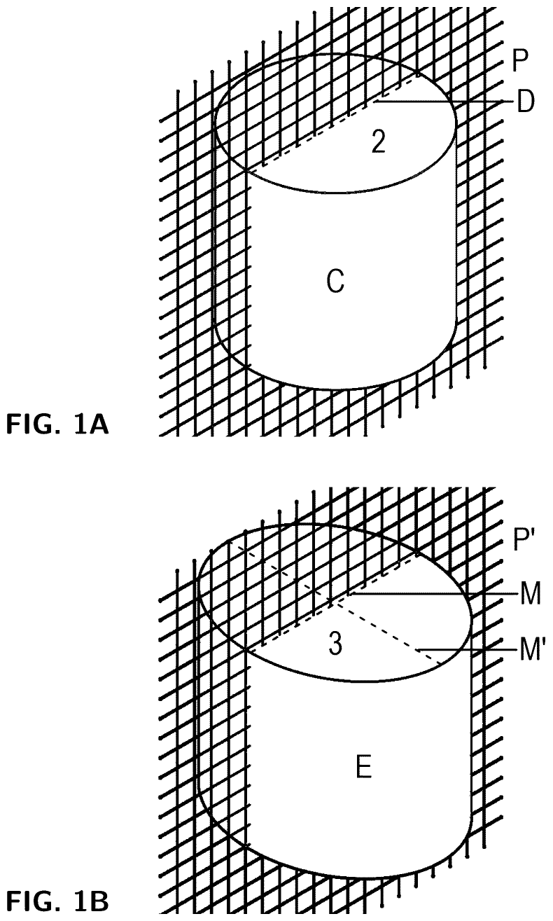

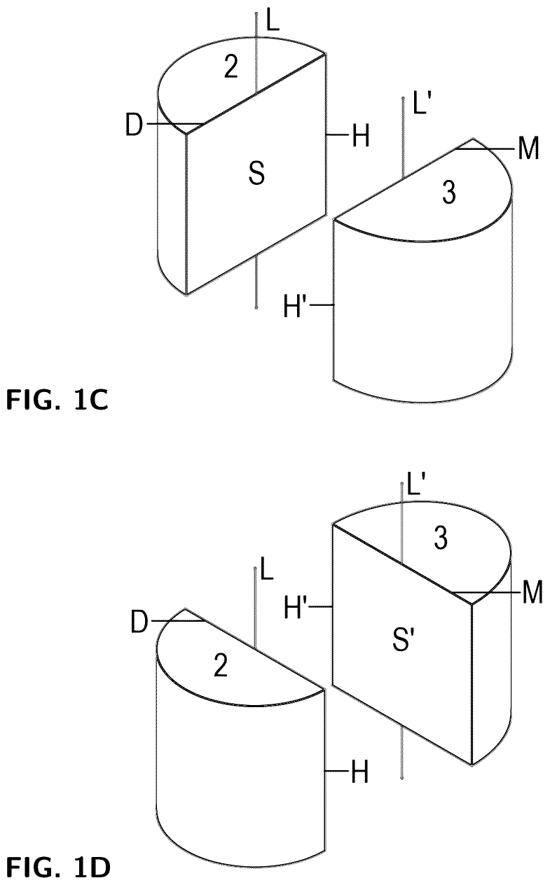

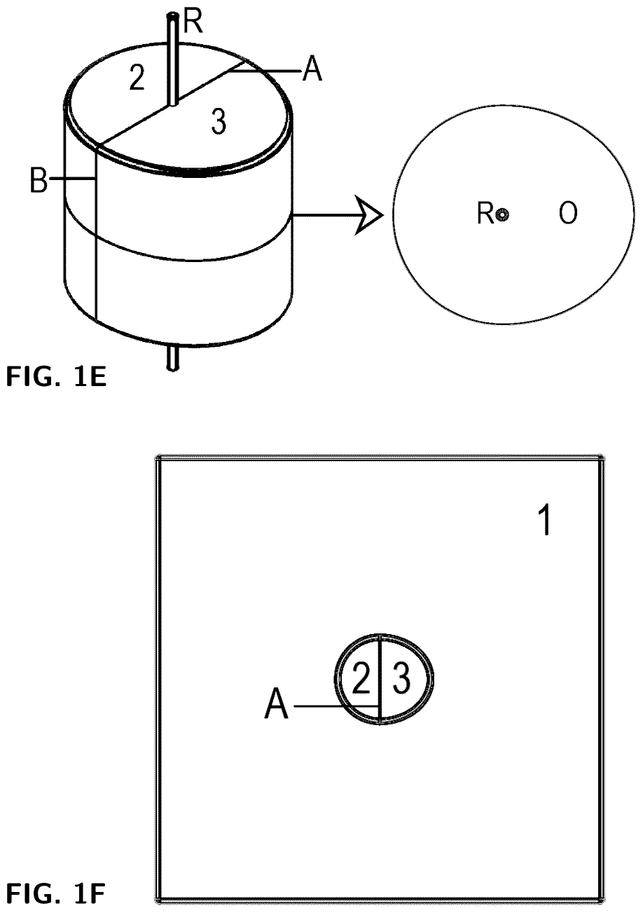

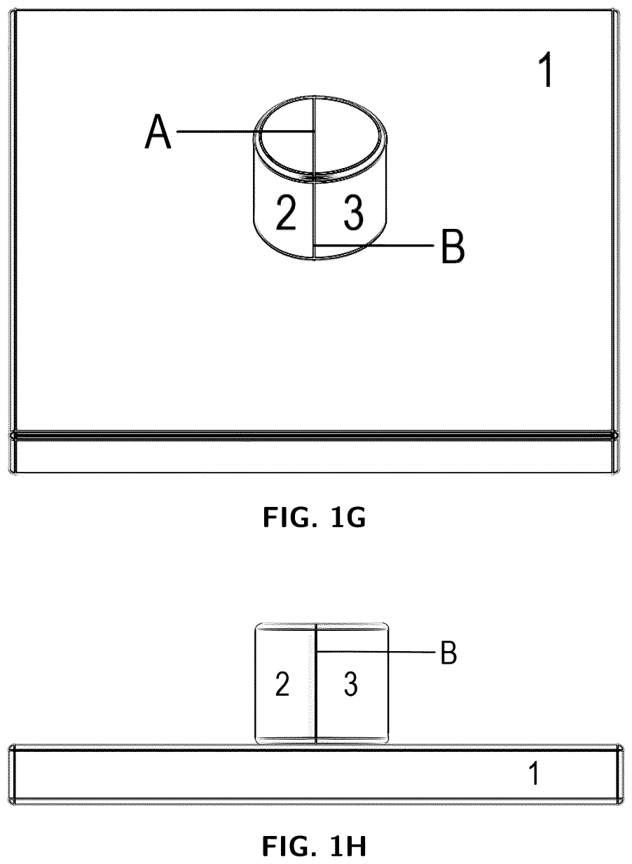

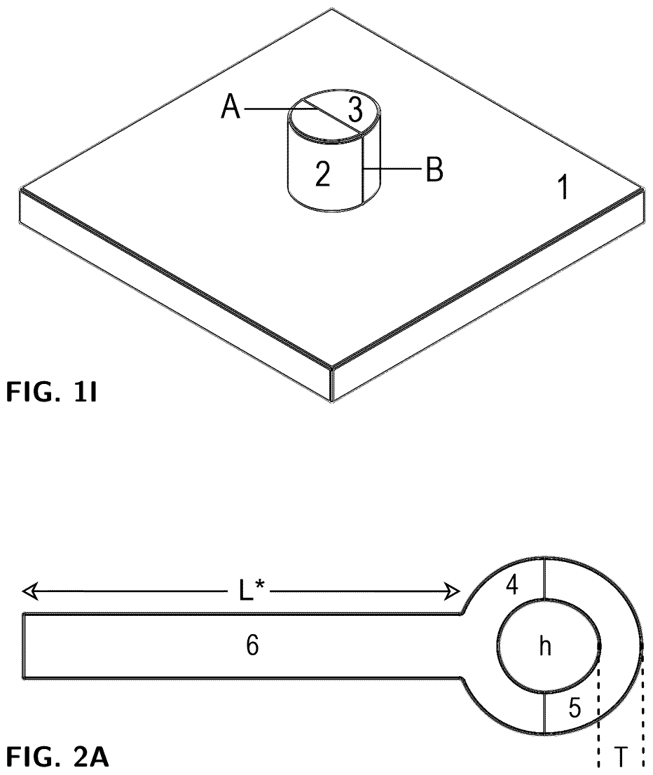

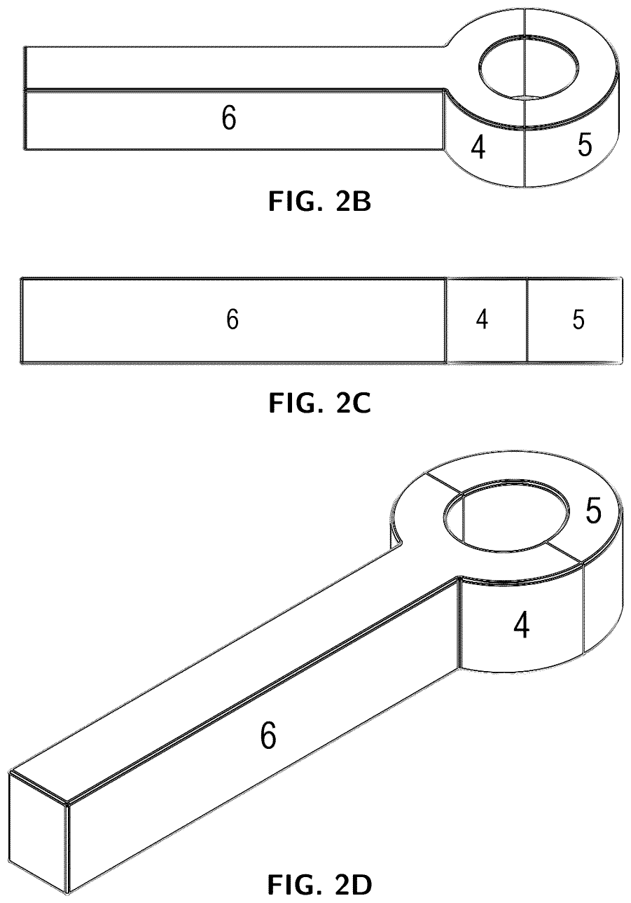

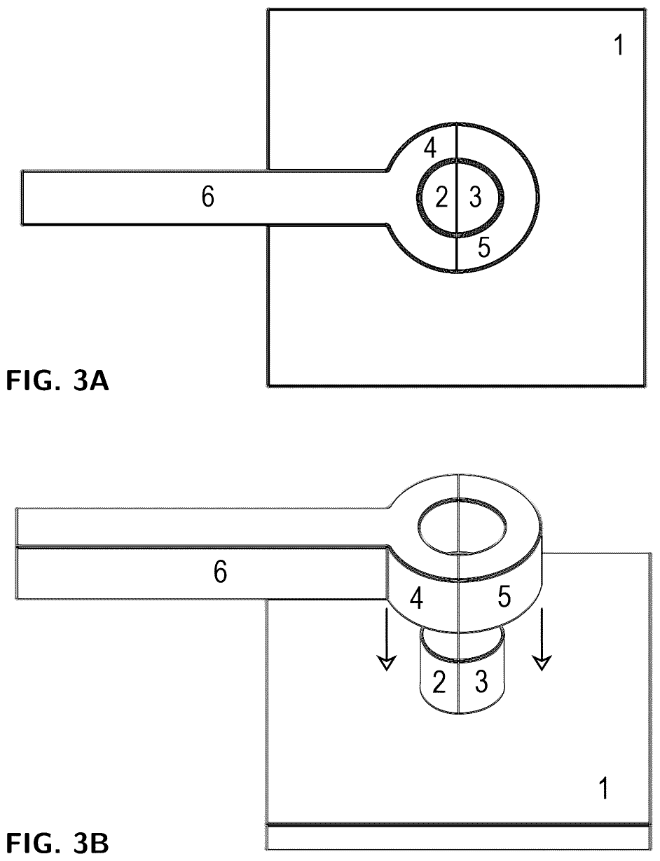

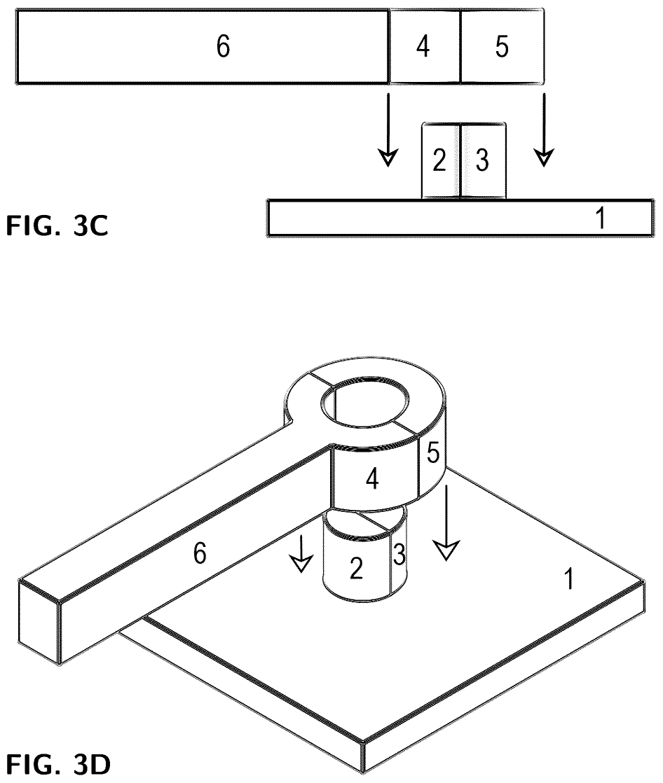

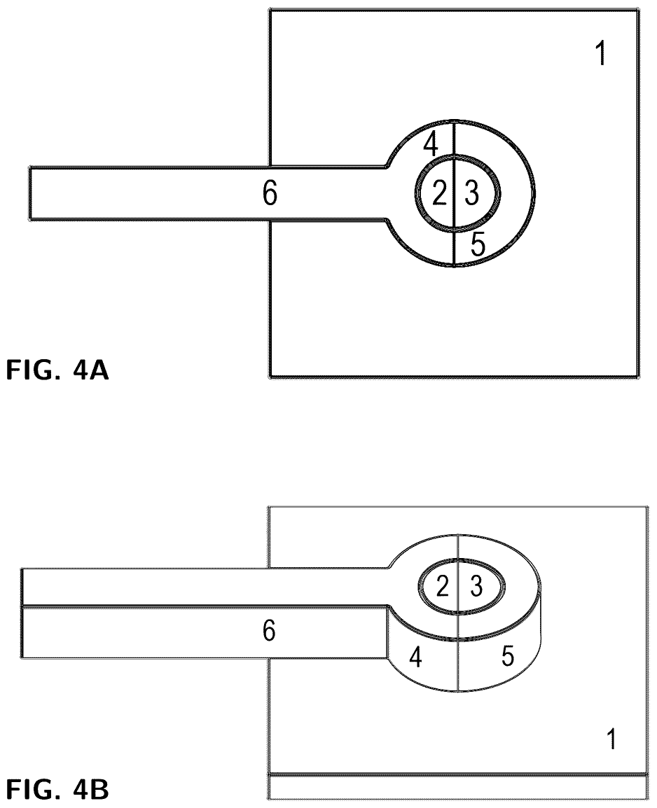

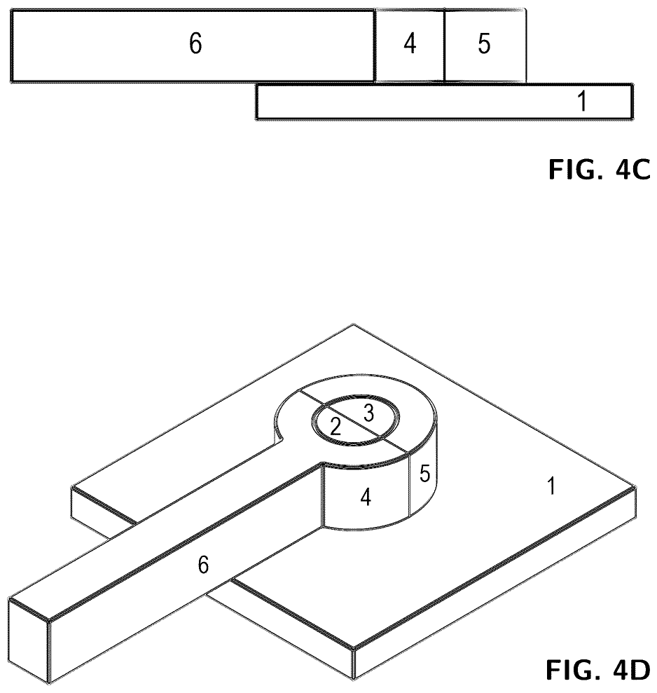

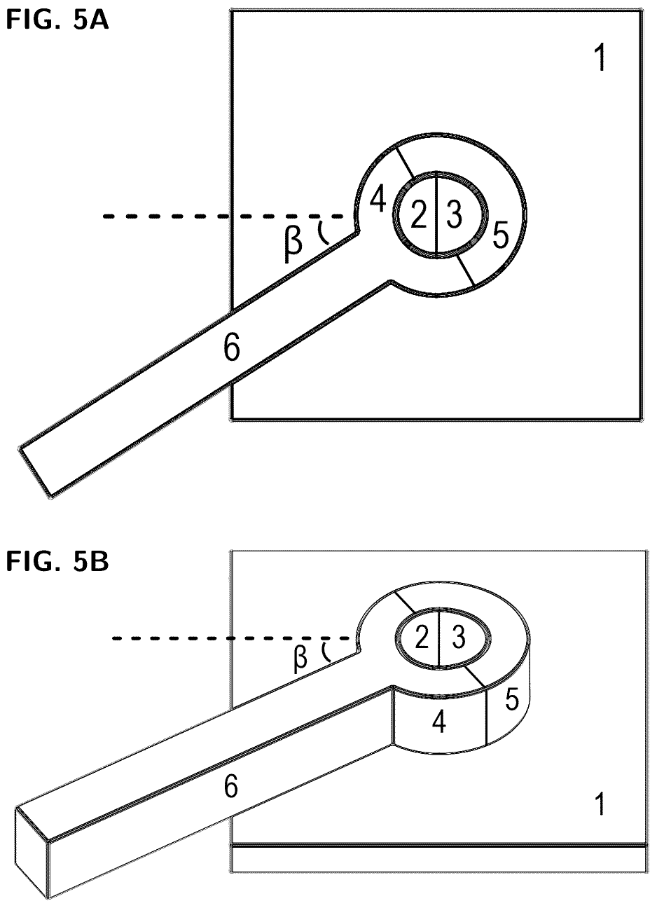

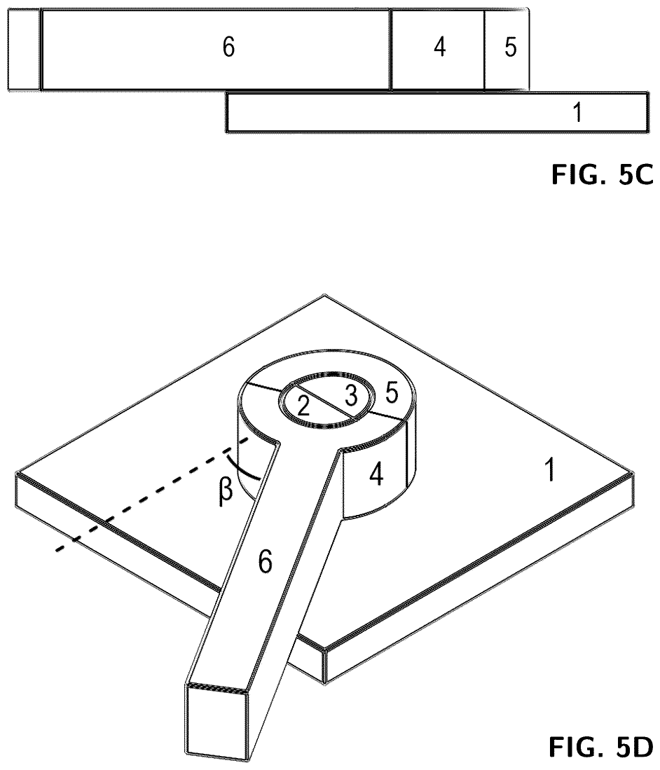

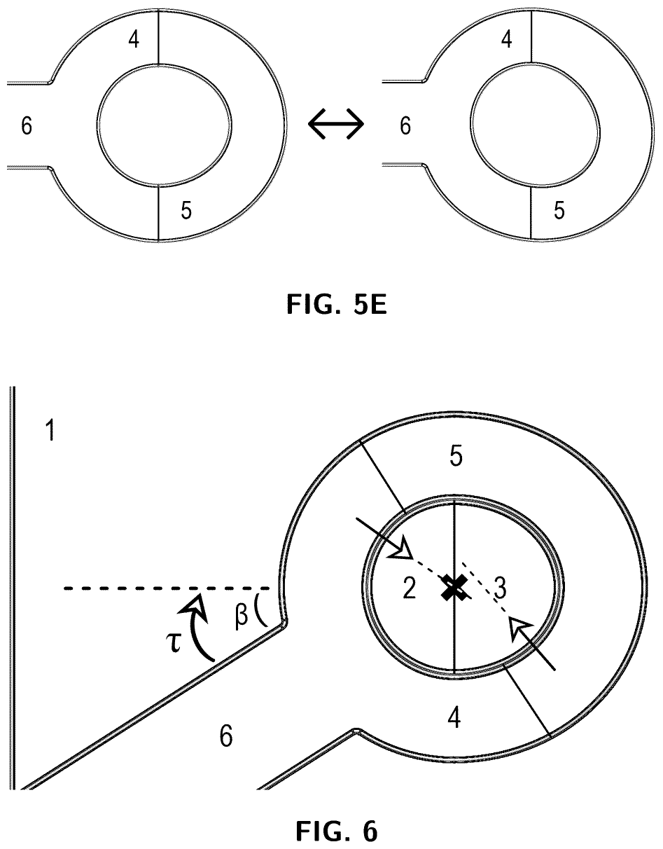

### DETAILED DESCRIPTION OF THE INVENTION

The torsion-spring mechanism of the present invention comprises two primary components: an oval-cylindrical pivot and a lever with an integrated knuckle-eye, which generates torque through elastic-deformation, enabling controlled torque-output and multi-position stability for advanced applications. The pivot, rigidly joined to a cuboidal platform, serves as a stationary and rotationally-constrained element, featuring a uniform oval cross-section perpendicular to its rotational-axis, thereby forming the system's rotational-base. Note that the oval-cylindrical shape of the pivot is formed by seamlessly joining circular and continuous non-circular semi-cylindrical sections along their identical surfaces, which result from splitting along respective diametral-planes. Furthermore, for generalized continuous non-circular profiles, eccentricity can be defined as the deviation of the profile's curvature from that of a circle, wherein a higher eccentricity corresponds to a greater deviation, thereby amplifying the geometric-mismatch and influencing the torque characteristics of the torsion-spring assembly. In the present embodiment, the continuous non-circular shape is exemplified as an ellipse. However, the invention is not restricted to this specific geometry, and alternative continuous non-circular profiles may be utilized while maintaining the fundamental torque-generation principle of the mechanism. Additionally, the heights and widths—i.e., diameter of the circular-section and minor-axis of the elliptical-section—are equal, with the latter being split along a diametral-plane passing through the minor-axis. The rotational-axis of the pivot is defined by aligning the longitudinal-axes of both sections into a common axis. Finally, the pivot's dimensions, along with the knuckle-eye's wall-thickness and the lever-arm's length, collectively influence the mechanism's behavior and overall performance.

The lever incorporates a knuckle-eye at one end, featuring a complementary oval-cylindrical hole designed to slidably engage the pivot with minimal clearance, ensuring proper constraint within its rotational limits. Similar to the pivot, the knuckle-eye can be conceptually divided into two halves: a circular semi-cylindrical wall formed around the circular semi-cylindrical section of the pivot and an elliptical semi-cylindrical wall formed around the elliptical semi-cylindrical section of the pivot. A lever-arm extends radially outward from the circular semi-cylindrical wall of the knuckle-eye, facilitating effective torque transmission and mechanical leverage, while also rendering the circular-wall rigid due to the additional mass at their joint, thereby preventing its distortion. Due to this, the wall is circular, ensuring smooth sliding motion around the circular-section of the pivot without deformation, as their constant curvatures remain aligned throughout rotation, thereby preventing any geometric-mismatch. This rigidity also defines the maximum angular-displacement of the lever, as it restricts the lever's rotation upon encountering the rigid elliptical-section of the pivot, which has a different curvature that cannot be accommodated through deformation, thereby preventing excessive deformation of the knuckle-eye that could lead to permanent yielding or failure.

Conversely, the opposing elliptical-wall of the knuckle-eye, interfacing with the elliptical-section of the pivot, is elastically-deformable, allowing torque generation through elastic shear-strain and resultant shear-stress. The surrounding knuckle-eye walls, defining the hole, possess a specified thickness that determines their stiffness and deformation characteristics, governing the system's torque response in the deformable-half.

In its primary function as a torsion-spring, the mechanism operates as follows: In the stable-equilibrium orientation, the knuckle-eye's hole aligns with the oval-pivot, experiencing no deformation. When an external torque applied to the lever-arm rotates the lever about the pivot's rotational-axis, the elastic elliptically-profiled wall of the knuckle-eye engages with the rigid elliptical semi-cylindrical section of the pivot, resulting in a geometric-mismatch due to their differing curvatures along the angular-displacement path, which induces localized shear-strain in the elliptical-wall as it elastically deforms to conform to the shape constraint imposed by the elliptical-section's rigid shape. The resultant shear-stress within the knuckle-eye's walls generates reaction-forces that oppose deformation and act to restore the knuckle-eye to its original shape. Due to the non-circular cross-section, the net reaction-force vectors form a force-couple at the pivot and knuckle-eye interface, as the vectors at their effective contact-points deviate from the pivot's rotational-axis. This force-couple induces a restoring-torque proportional to the angular-displacement, effectively counteracting the applied external torque. Upon release of the external torque, the restoring-torque drives the lever back to its stable-equilibrium orientation by converting the stored potential-energy of the elastic-deformation back into mechanical rotational-motion. Note that the magnitude of the restoring-torque is precisely tunable and depends on the following key factors:
1. Elastic Properties of the Knuckle-Eye Material: Materials with higher elastic-modulus (e.g., stiff spring-steel) produce greater shear-stress per unit shear-strain, leading to a steeper restoring-torque gradient per unit angular-displacement. In contrast, materials with lower elastic-modulus (e.g., polymer-composites) allow greater shear-strain per unit shear-stress, resulting in a more gradual and flexible restoring-torque response. Further, a higher yield-strength enhances the material's resistance to permanent deformation, ensuring that the knuckle-eye can withstand repeated loading-cycles while maintaining its structural-integrity and torque-response, and vice-versa.
2. Thickness of the Knuckle-Eye Walls: Thicker walls enhance the knuckle-eye's resistance to elastic-deformation by increasing its shear-strength, resulting in a higher shear-stress per unit shear-strain and, consequently, a greater restoring-torque gradient per unit angular-displacement, and vice-versa.
3. Eccentricity of the Elliptical Half: A greater difference between the major and minor axes of the pivot's elliptical-section increases the elastic-deformation required in the knuckle-eye's elliptical-wall per unit angular-displacement and also shifts the reaction-force vector of the force-couple farther from the pivot's rotational-axis, amplifying the restoring-torque gradient, and vice-versa.
4. Dimensions of the Torsion-Spring Assembly: Larger overall dimensions, including the pivot, knuckle-eye and lever-arm sizes, along with scale factors, amplify the strain and stress distributions, mechanical-leverage and torque-characteristics, as well as the maximum angular-displacement and load-bearing capacity, and vice-versa.
5. Length of the Lever Arm: A longer lever-arm increases the moment-arm, amplifying the applied torque for an external force and proportionally increasing the restoring-torque response, and vice-versa.
6. Angular Displacement of the Lever: A larger angular-displacement from the stable-equilibrium orientation induces greater elastic-deformation in the knuckle-eye, thereby increasing resultant shear strain and stress, which in turn yields a higher restoring-torque, and vice-versa.

Note that the rigid joint between the pivot and the platform ensures consistent torque generation by providing a stable anchor-point, while the minimal clearance between the knuckle-eye and the pivot prevents flexing or wobbling that could compromise structural integrity and performance due to misalignments. These design features enhance durability and reliability, particularly under repeated loading cycles and variable torque conditions.

Key advantages of the Oval-pivot Torsion-spring design include:
1. Simplified Construction: Eliminates the complexity of traditional coiled torsion-springs, minimizing manufacturing and assembly requirements.
2. Compact Design: Optimized for space-constrained applications, delivering high torque output within a minimal footprint by eliminating traditional coiled torsion-springs.
3. Customizable Torque Response: Allows precise tuning of restoring-torque characteristics through strategic geometric modifications and material selections.
4. Enhanced Durability: Eliminates fatigue-prone coils, enhancing longevity and reliability, particularly when subjected to cyclic loading and variable torque demands.

The invention has been described in detail with emphasis on its basic implementation to demonstrate its fundamental working-principle, but it will be appreciated that modifications and variations can be made within the spirit and scope of the invention to incorporate the following advanced implementations:
1. Alternative Diametral Plane Configurations: The torsion-spring mechanism can be implemented in two configurations, wherein the flat diametral-plane passes through either the minor-axis or the major-axis of the pivot's elliptical semi-cylindrical section. In both the variations, deformation of the knuckle-eye due to geometric-mismatch with the pivot follows distinct oval shape-profiles, modifying the restoring-torque characteristics while retaining the core functionality of the invention.
2. Advanced Oval Pivot Geometry: By incorporating an eccentricity gradient along the pivot's elliptical-section and/or varying the knuckle-eye's wall-thickness in the deformable half, either circumferentially and/or longitudinally in both the components, the mechanism can generate a complex torque response-such as a steep initial torque rise followed by a plateau-customized for applications like soft-close mechanisms or other progressive-resistance systems.
3. Multi-Stable Equilibrium Mechanism: A complex pivot may be designed as a superposition of multiple simple oval-pivot profiles, each with its own circular and elliptical semi-cylindrical section, arranged along their common rotational-axis and/or cross-section. This configuration enables the knuckle-eye to encounter varying geometric constraints at different rotational-angles, allowing the mechanism to achieve multiple stable-equilibrium orientations (e.g., at 0°, 30° and 75°). Moreover, in applications such as detent-knobs and mechanical indexing mechanisms, the knuckle-eye can function independently without a lever-arm, which makes its circular-wall elastically-deformable just like its elliptical-wall, thereby eliminating the maximum rotational limit and enabling unrestricted 360° rotation.
4. Multi-Material Construction: The pivot, lever-arm and rigid cylindrical-wall of the knuckle-eye may be constructed from stiff materials such as hardened stainless-steel, aerospace-grade aluminum-alloys (e.g., 7075-T6) and high-performance engineering polymers (e.g., PEEK or Ultem) to ensure structural-integrity, resist wear and enhance load-bearing capacity. In contrast, the deformable elliptical-wall of the knuckle-eye is made from elastic materials like hardened spring steel (e.g., 1095 or 5160), fiber-reinforced thermoplastics (e.g., glass-filled nylon or carbon-fiber-reinforced PEEK) and advanced composite materials (e.g., CFRP or Kevlar laminates), thereby enabling elastic-deformation and long-term durability under repeated loading cycles.
5. Modular Pivot Design: The proportion of the circular and elliptical sections of the pivot can be adjusted to customize the rotational-limit and restoring-torque characteristics for specific applications. Additionally, the torsion-spring assembly can incorporate interchangeable segments with varying eccentricities, sizes, knuckle-eye wall thicknesses, lever-arm lengths and material properties, allowing users to fine-tune the restoring-torque characteristics, stable-equilibrium orientations and overall system performance by swapping individual components, which can be assembled using mechanical-joints such as bolts and rivets. Furthermore, instead of being fused, the pivot can be inserted into a hole in the platform and secured using locking-lugs. This modular approach facilitates easier assembly and disassembly, making it particularly advantageous for prototyping, customizable tools and field adjustments in industrial applications, depending on design requirements and material compatibility.
6. Versatile Manufacturing Techniques: Manufacturing methods for the torsion-spring assembly accommodate a spectrum of techniques, encompassing casting, forging, precision-machining, injection-molding, and additive or subtractive processes. For advanced implementations requiring multi-profile pivots or multi-material components, hybrid-layered manufacturing (HLM) offers a potent fabrication strategy.
7. Versatile Applications and Key Advantages: Potential applications for the torsion-spring mechanism are diverse and include, but are not limited to, hinges, clamps, automotive and robotic components, multi-position locking systems and adjustable fixtures, particularly in systems requiring precise positional control for accurate and repeatable positioning. Its compact design, tunable torque-profile and enhanced stability make it especially advantageous in space-constrained applications where reliable and finely controlled torque-output is essential.

I claim:

1. A torsion-spring assembly comprising:
a pivot having an oval cross-section throughout, perpendicular to its rotational-axis, wherein:
a first half of the pivot is a circular semi-cylindrical section split along a first diametral-plane,
a second half of the pivot is a continuous non-circular semi-cylindrical section split along a second diametral-plane, surfaces formed by the diametral-planes are geometrically-congruent and coincident, longitudinal-axes of both the sections coincide to form the rotational-axis, and
a cuboidal platform forms the rotational-base of the pivot;
a lever having a knuckle-eye with a hole complementary to the pivot, the hole defining a circular semi-cylindrical wall and a continuous non-circular semi-cylindrical wall, wherein a lever-arm extends from the circular semi-cylindrical wall; and
wherein rotating the lever from a stable-equilibrium orientation about the pivot elastically deforms the knuckle-eye, generating a restoring-torque that acts to return the lever to the stable-equilibrium orientation upon release, the magnitude of the restoring-torque being a function of:
eccentricity of the continuous non-circular semi-cylindrical section of the pivot,
elastic-properties of a material capable of reversible-deformation forming the continuous non-circular semi-cylindrical wall of the knuckle-eye,
thickness of the continuous non-circular semi-cylindrical wall of the knuckle-eye,
dimensions of the torsion-spring assembly,
length of the lever-arm, and
angular-displacement of the lever from the stable-equilibrium orientation.

2. A method of generating a restoring-torque by using the torsion-spring assembly of claim 1, comprising:
mounting the knuckle-eye of the lever onto the pivot;
rotating the lever about the pivot from the stable-equilibrium orientation to elastically deform the knuckle-eye, generating the restoring-torque; and
releasing the lever, whereby the restoring-torque returns the lever to the stable-equilibrium orientation.
